(19) United States
(12) Patent Application Publication
(10) Pub. No.: US 2005/0237704 A1
(43) Pub. Date: Oct. 27, 2005

(54) Wristdrive

(76) Inventor: Carl Ceresoli, Cumming, GA (US)

Correspondence Address: PATTON BOGGS LLP, 8484 WESTPARK DRIVE, SUITE 900, MCLEAN, VA, 22102, US

(21) Appl. No.: 10/829,271

(22) Filed: Apr. 22, 2004

(51) Int. Cl. G06F 1/16

(52) U.S. Cl. 361/683

(57) ABSTRACT

The invention includes a wearable data storage device having a data storage unit, a non-clasping data transmitter, a non-clasping data receiver, a male clasping data connector, a female clasping data connector, and a band. The male clasping data connector is at one end of the band and the female clasping data connector is at the other end of the band. The invention also includes methods of transferring data using the wearable data storage device.

### FIELD OF THE INVENTION

The present invention is directed generally to data storage devices and specifically to data storage devices that can be worn on the human body.

### BACKGROUND OF THE INVENTION

Portable data storage media such as floppy drives and removable hard drives are known. In recent years portable flash memory chips and memory sticks for applications such as digital cameras have been introduced. In addition, pagers with digital displays, cell phones with digital displays and personal digital assistants (PDA) are known. These are typically relatively large and are carried by their owners in the pockets of their of pants or jacket or in purses or backpacks. Some models of cell phones and PDAs come with holders that are designed to attach to belt. However, these are still bulky and awkward. Recently, the Japanese telecom giant DoCoMo began selling a cell phone that can be worn on the wrist. However, the “Wristomo” does not allow the users to directly transfer data from Wristomo to Wristomo.

Currently there are no data storage devices that have specifically been designed to be worn by the user. In particular, there are no wearable data storage devices that allow multiple users to directly share data. That is, no wearable data storage devices that allow users to transmit and receive data to each other without transmitting the data over a network. Therefore, there is a need for a highly portable, wearable data storage device with the security direct data transfer.

### SUMMARY OF THE INVENTION

The present invention provides a wearable data storage device comprising a data storage unit, a non-clasping data transmitter, a non-clasping data receiver, a male clasping data connector, a female clasping data connector, and a band having a first end and a second end, wherein the first end of the band comprises the male clasping data connector and the second end of the band comprises the female clasping data connector.

The present invention also includes a method of transferring data comprising connecting a non-clasping data transmitter on a first wearable data storage device to a non-clasping data receiver on a second wearable data storage device.

The present invention also includes a method of transferring data comprising connecting the male clasping data connector of a first wearable data storage device to personal computer.

### BRIEF DESCRIPTION OF THE DRAWINGS

The foregoing and other features, aspects and advantages of the present invention will become apparent from the following description, appended claims and the exemplary embodiments shown in the drawings, which are briefly described below. It should be noted that unless otherwise specified like elements have the same reference numbers.

FIG. 1 is a perspective view illustrating a wristdrive according to one embodiment of the invention.

FIG. 2 is a perspective view illustrating a method of transferring data according from one wristdrive to another wristdrive to one embodiment of the invention.

FIG. 3 is a close-up of the non-clasping data transmitters and receivers of the wristdrives illustrated in FIG. 2.

FIG. 4 is a perspective view illustrating a method of transferring data according a second embodiment of the invention.

FIG. 5 is a close-up of the clasping data transmitters and receivers of the wristdrives illustrated in FIG. 4.

FIG. 6 is a perspective view illustrating a clasping mechanism according to one embodiment of the invention.

FIG. 7 is a perspective view of a rotating display according to one embodiment of the invention.

### DETAILED DESCRIPTION OF THE PREFERRED EMBODIMENTS

The present inventor has discovered that it is possible to make a wearable data storage device having several different data transfer mechanisms. In particular, one of the data transfer mechanisms may form a clasp suitable for keeping the wearable data storage device on the wearer. Another data transfer mechanism can transfer data while the device is being worn, that is while the first data transfer mechanism clasped. The wearable data storage device of the present invention is highly portable and has the security direct data transfer from device to device.

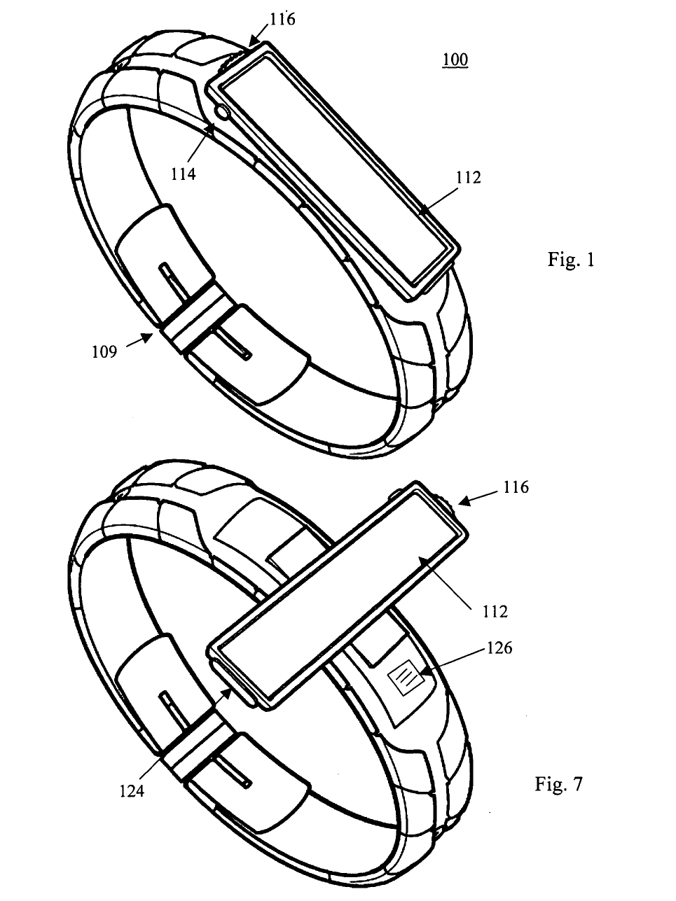

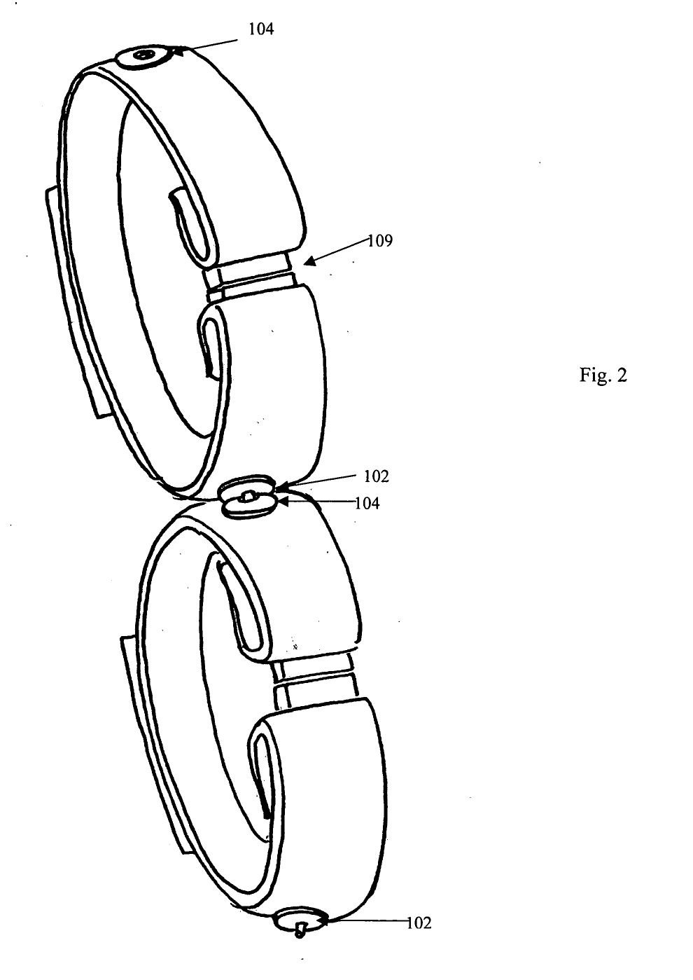

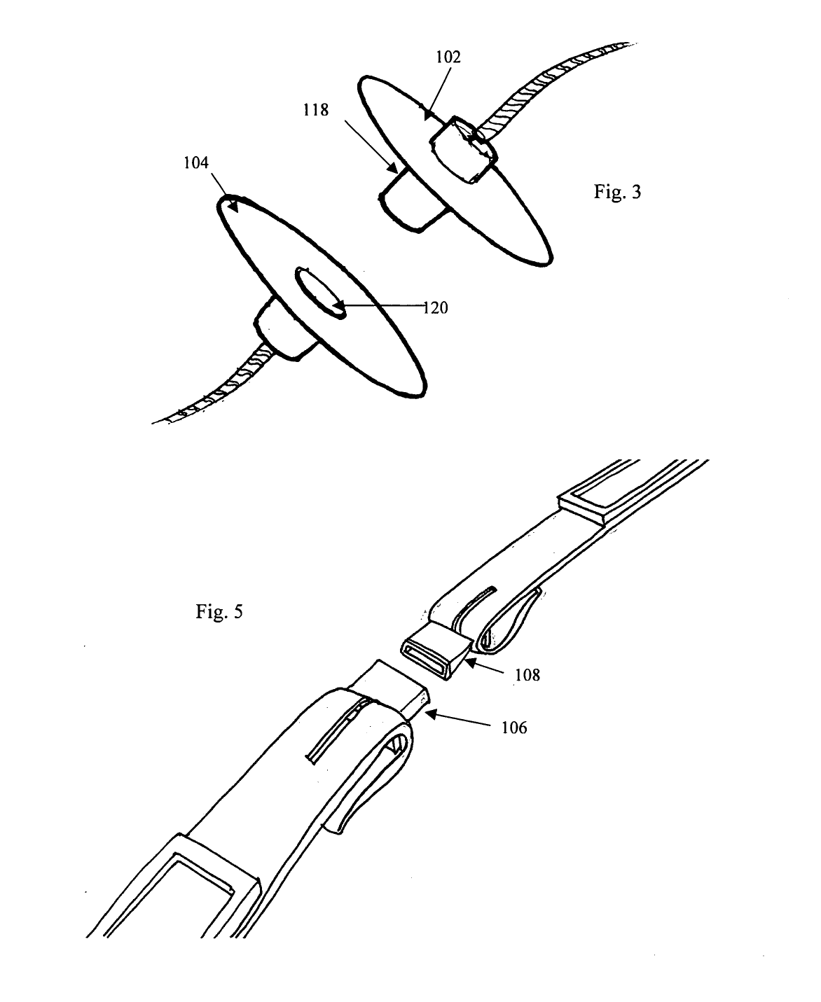

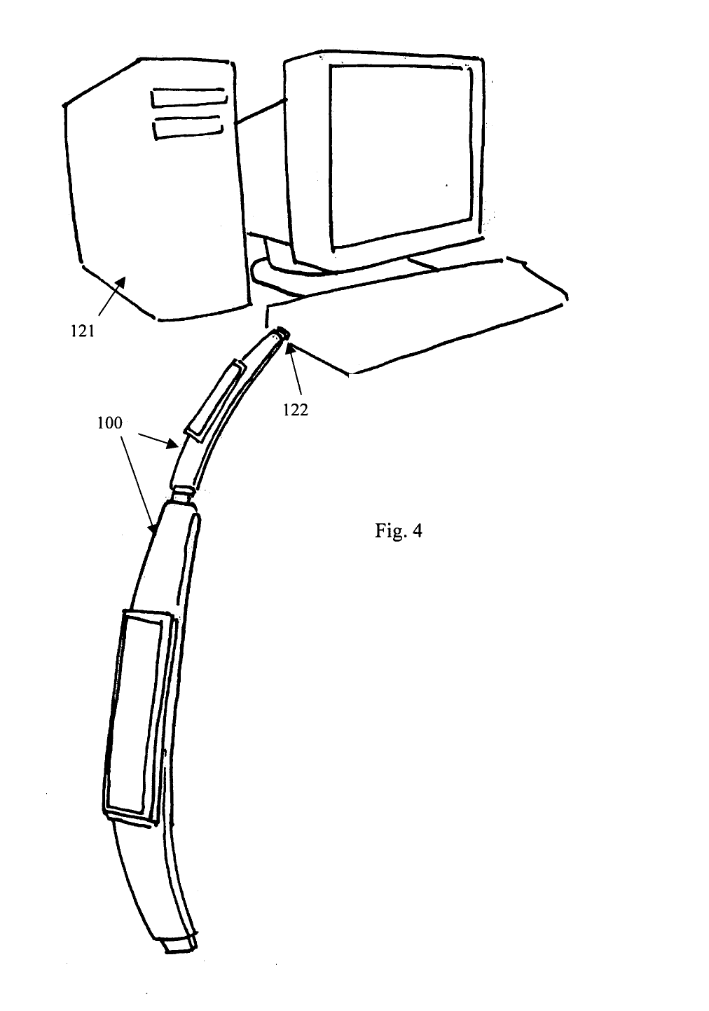

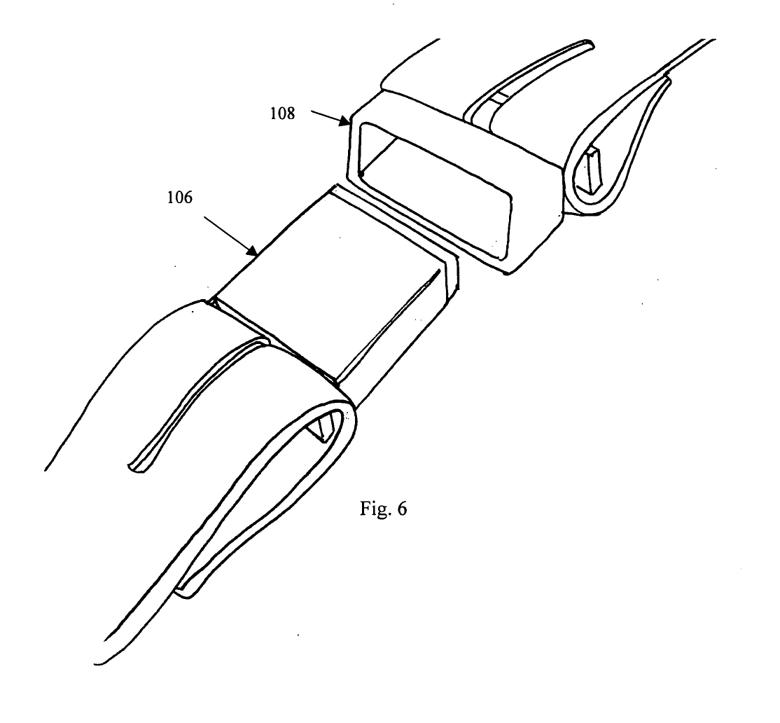

Various embodiments of the wearable data storage device and methods of using the wearable data storage devices are illustrated in FIGS. 1-7. In the first embodiment of the invention, the wearable data storage device 100 includes a data storage unit 101, a non-clasping data transmitter 102, a non-clasping data receiver 104, a male clasping data connector 106, and a female clasping data connector 108. The wearable data storage device 100 also includes a band 110. One end of the band terminates with the male clasping data connector 106 while the other end of the band terminates with the female clasping data connector.

Preferably, the data storage unit 101 is a flash memory chip. However, the data storage unit 101 may also be a micro hard drive or a nano-storage device. Additionally, the wearable data storage device 100 preferably includes a display 112. Typically the display 112 is rectangular but it may be round, square, or any other shape.

Preferably, the display 112 can rotate (FIG. 7). Thus, if the display 112 is rectangular, it may be oriented in both portrait and landscape orientations. Additionally, it is preferable that the display is adapted to display text, that is, ASCII characters. More preferably, the display is adapted to display both text and graphics.

The wearable data storage device 100 preferably includes at least one button 114 to access and control operating system software used to operate the data storage device 100. Additionally, the wearable data storage device 100 may include a separate button 116 to control the scrolling of text across the display. The buttons 114, 116 may be push buttons or rotating scroll buttons or combinations thereof.

In one embodiment of the invention, the non-clasping data transmitter 102 of a first wearable data storage device 100 is adapted to transfer data to the non-clasping data receiver 104 of a second wearable data storage device 100 by touching. As illustrated in FIG. 3, the non-clasping data transmitter 102 may include a plug 118 which is adapted to fit into a socket 120 in the non-clasping data receiver 104. In another embodiment of the invention, both the non-clasping data transmitter 102 and the non-clasping data receiver 104 operate with infrared technology. Thus, it is not necessary for the wearable data storage devices 100 of this embodiment to actually touch in order to transfer data.

In one preferred embodiment of the wearable data storage device 100, the male clasping data connector 106 of a first wearable data storage device 100 is adapted to transfer data to the female clasping data connector 108 of a second wearable data storage device 100. Further, more than two wearable data storage devices 100 can be connected in this manner. That is, multiple wearable storage devices 100 may be connected in a daisy-chain. The total length of the daisy-chain is governed primarily by the software's ability to handle the inputs of the wearable data storage devices 100 in the daisy-chain.

In one embodiment of the invention, the male clasping data connector 106 of the wearable data storage device 100 is designed to communicate with a personal computer 121 through the personal computer's 121 USB port 122. However, it is not necessary to connect through the USB port 122. In other embodiments of the invention, the male clasping data connector 106 of the wearable data storage device 100 is designed to communicate with a personal computer 121 through either the personal computer's 120 serial (not shown) or parallel ports (not shown). Further, the invention is not limited to these modes of communications. Any form of communication in which the male clasping data connector 106 of the wearable data storage device 100 is designed to communicate with a personal computer 121 is within the scope of the present invention.

In another preferred embodiment of the invention, the wearable data storage device 100 includes operating system software. In one embodiment, the software allows the wearable data storage device 100 to synchronize with a calendar program on the personal computer 121. In another embodiment the wearable data storage device 100 can synchronize with an email program on the personal computer 121. In still another embodiment, the wearable data storage device 100 can synchronize with websites on the internet. In other embodiments of the invention, the wearable data storage device 100 may synchronize with any combination of the programs discussed above.

Preferably, the male clasping data connector 106 and the female clasping data connector 108 combine to form a clasping mechanism 109. That is, when the male clasping data connector 106 is inserted into the female clasping data connector 108, the connection is robust enough to secure the wearable data storage device 100 so that the clasp 109 does not come undone by itself while being worn. Additionally, because the sizes of human wrists vary, it is preferable that the band 110 is adjustable.

In another embodiment, the wearable data storage device 100 includes a backlight 124 that can be used to illuminate the display 116. Thus, text and images can be easily read at night or in a poorly lit room. Optionally, the wearable data storage device 100 may also include a speaker 126. With this option, the user may enjoy both audio and visual data.

In still another embodiment of the invention, the wearable data storage device 100 includes a traditional clasping mechanism 109, that is, a clasping mechanism 109 that neither transmits nor receives data. However, this embodiment also includes a male clasping data connector 106 and a female clasping data connector 108 that are capable of transmitting and receiving data. In this embodiment, the male clasping data connector 106 and the female clasping data connector 108 are not used to secure the wearable data storage device 100. Rather, the male clasping data connector 106 and the female clasping data connector 108 are attached to the side of the band 110 and are available to transmit and receive data.

In a first method of transferring data according to the invention, data is transferred by connecting a non-clasping data transmitter 102 on a first wearable data storage device 100 to a non-clasping data receiver 104 on a second wearable data storage device 100. This is typically accomplished by inserting a plug of a male a non-clasping data transmitter 102 into a socket of a female non-clasping data receiver 104. In this manner users can share data without having to remove their wearable data storage devices 100.

In another embodiment of the method, the wearable data storage devices 100 include infrared operated non-clasping data transmitters 102 and non-clasping data receivers 104. In this embodiment, the users do not have to actually touch the non-clasping data transmitters 102 to the non-clasping data receivers 104 to form a data connection. That is, non-clasping data transmitters 102 need only be in IR range of the non-clasping data receivers 104.

In another method of transferring data according to the invention, the male clasping data connector 106 of a first wearable data storage device 100 is connected to personal computer 121. In this manner, data may be transferred from the personal computer 121 to the wearable data storage device 100. Alternatively, data may be transferred from the wearable data storage device 100 to the personal computer 121.

In still another method, the male clasping data connector 106 of a first wearable data storage device 100 may be connected to a female clasping data connector 108 of a second wearable data storage device 100. In this manner, data may be transferred from the first wearable data storage device 100 to the second wearable data storage device 100. Further, additional wearable data storage devices 100 may be connected in the same manner to for a daisy-chain of wearable data storage devices 100. In this manner, data can be shared among all of the wearable data storage devices 100. Additionally, the last device in the daisy-chain may be connected to a personal computer 121. In this manner, data from the computer can be shared with all of the wearable data storage devices 100 in the daisy chain. Alternatively, data from all of the wearable data storage devices 100 in the daisy-chain may be uploaded to the personal computer 121.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen to explain the principles of the invention and its practical application. It is intended that the scope of the invention be defined by the claims appended hereto, and their equivalents.

1. A wearable data storage device comprising:
a data storage unit;
a non-clasping data transmitter;
a non-clasping data receiver;
a male clasping data connector;
a female clasping data connector; and
a band having a first end and a second end,
wherein the first end of the band comprises the male clasping data connector and the second end of the band comprises the female clasping data connector.

2. The wearable data storage device of claim 1, wherein the data storage unit is a flash memory chip.

3. The wearable data storage device of claim 1, further comprising a display.

4. The wearable data storage device of claim 3, wherein the display is adapted to rotate.

5. The wearable data storage device of claim 4, wherein the display is adapted to display text.

6. The wearable data storage device of claim 5, wherein the display is adapted to display both text and graphics.

7. The wearable data storage device of claim 4, further comprising at least one button.

8. The wearable data storage device of claim 4, wherein the at least one button is a push button or a scroll button.

9. The wearable data storage device of claim 1, wherein the non-clasping data transmitter of a first wearable data storage device is adapted to transfer data to the non-clasping data receiver of a second wearable data storage device.

10. The wearable data storage device of claim 9, wherein the non-clasping data transmitter and the non-clasping data receiver use infrared technology.

11. The wearable data storage device of claim 1, wherein the male clasping data connector of a first wearable data storage device is adapted to transfer data to the female clasping data connector of a second wearable data storage device.

12. The wearable data storage device of claim 11, wherein a plurality of wearable storage devices are adapted to be daisy-chained by connecting the male clasping data connector of one wearable data storage device to the female clasping data connector of the succeeding wearable data storage device in the daisy-chain.

13. The wearable data storage device of claim 12, wherein the wearable data storage device is adapted to communicate with a personal computer through the personal computer's USB port.

14. The wearable data storage device of claim 13, wherein the wearable data storage device is adapted to synchronize with a calendar program on the personal computer.

15. The wearable data storage device of claim 13, wherein the wearable data storage device is adapted to synchronize with an email program on the personal computer.

16. The wearable data storage device of claim 15, wherein the wearable data storage device is adapted to synchronize with websites on the internet.

17. The wearable data storage device of claim 1, wherein the male clasping data connector and the female clasping data connector form a clasping mechanism.

18. The wearable data storage device of claim 1, wherein the band is adjustable.

19. The wearable data storage device of claim 1, further comprising a backlight.

20. The wearable data storage device of claim 1, further comprising a speaker.

21. The wearable data storage device of claim 1, wherein the male and female data clasping connectors are selected from the groups consisting of USB, serial, and parallel.

22. A method of transferring data comprising:
connecting a non-clasping data transmitter on a first wearable data storage device to a non-clasping data receiver on a second wearable data storage device.

23. A method of transferring data comprising:
connecting the male clasping data connector of a first wearable data storage device to personal computer.

24. The method of claim 23, further comprising connecting the male clasping data connector of a first wearable data storage device to a female clasping data connector of a second wearable data storage device.

25. The method of claim 23, further comprising synchronizing calendar data in the computer with calendar data in the first wearable data storage device.

26. The method of claim 23, further comprising synchronizing email data in the computer with calendar data in the first wearable data storage device.

27. The method of claim 23, further comprising synchronizing data from websites on the internet with data in the first wearable data storage device.

28. A wearable data storage device comprising:
a data storage unit;
a non-clasping data transmitter;
a non-clasping data receiver;
a male clasping data connector;
a female clasping data connector; and
a band having a first end and a second end,
wherein the male clasping data connector is located proximal to the first end of the band and the female clasping data connector is located is located proximal to the second end of the band.

29. The wearable data storage device of claim 28, wherein the male clasping data connector and the female clasping data connector are located on the side of the band.

30. The wearable data storage device of claim 29, further comprising a clasping mechanism which can neither transmit nor receive data.
